(19) United States
(12) Patent Application Publication
(10) Pub. No.: US 2017/0315356 A1
(43) Pub. Date: Nov. 2, 2017

(54) WAVEGUIDES OF NEAR-EYE DISPLAY DEVICES FOR SUPPRESSING GHOST IMAGES

(71) Applicant: Jani Kari Tapio Tervo, Espoo (FI)

(72) Inventor: Jani Kari Tapio Tervo, Espoo (FI)

(21) Appl. No.: 15/141,459

(22) Filed: Apr. 28, 2016

(51) Int. Cl. G02B 27/01; F21V 8/00; G02B 27/00; G02B 27/42

(52) U.S. Cl. CPC G02B 27/0172; G02B 27/4205; G02B 6/0088; G02B 27/0018; G02B 6/0076; G02B 27/0176; G02B 2027/012; G02B 2027/0161; G02B 2027/0198

(57) ABSTRACT

Disclosed are an apparatus and method for reducing ghost image effects and rainbow effects in a near-eye display device. The near-eye display device includes an imager to generate an image based on light from a light source. The near-eye display device further includes at least one planar waveguide. The waveguide inputs light representing the image from the imager at an input surface and outputs the light representing the image toward an optical receptor of a user from an output surface. The waveguide is mounted in an opposite tilt angle. The tilt angle of the waveguide and grating periods of diffraction optical elements of the waveguide serve to reduce ghost image effects and rainbow effects.

### BACKGROUND

Near-eye display (NED) devices such as head-mounted display (HMD) devices have been introduced into the consumer marketplace recently to support visualization technologies such as augmented reality (AR) and virtual reality (VR). A near-eye display device may include components such as one or more light sources, microdisplay modules, controlling electronics, and various optics such as waveguides, lenses, beam splitters, etc.

Waveguides may be used in a near-eye display device to convey light representing artificially-generated images from the image generation components of the device to an eye of a user. One or more of these waveguides may act as the device's image output interface to the user; these waveguides can be referred to as “output waveguides” of the device. For example, with a near-eye AR device, the user may see computer-generated images projected from a transparent output waveguide while the user views the real world through the output waveguide. In this way, the computer-generated images appear to be superimposed over the user's real-world environment.

Some waveguides in a near-eye display device may include diffraction optical elements that split the light into multiple light beams of different diffraction orders. Light of a desired diffraction order exits the output waveguide and reaches the eye of the user. However, light of other (undesired) diffraction orders may also continue propagating in the output waveguide and therefore may also reach the eye. The light of undesired diffraction orders can cause ghost images to be super-imposed on the main (desired) image, which reduces the overall image quality for the user.

Furthermore, ambient light from light sources external to the near-eye display device (e.g., the sun or indoor lighting) may reach the output waveguides of the device, particularly though not exclusively with AR near-eye devices. The ambient light typically has a wide spectrum and therefore contains light of different colors. The diffraction optical elements in the output waveguide tend to separate the ambient light into beams of different colors, which can undesirably cause the user to perceive a rainbow effect.

### SUMMARY

Introduced here are at least one apparatus and at least one method (collectively and individually, “the technique introduced here”) for reducing ghost image effects and rainbow effects caused by diffraction optical elements (DOEs) of a display device, particularly (though not necessarily) a near-eye display device. The following description generally assumes that the “user” of the display device is a human, to facilitate description. Note, however, that a display device embodying the technique introduced here can potentially be used by a user that is not human, such as a machine or an animal. Hence, the term “user” herein can refer to any of those possibilities, except as may be otherwise stated or evident from the context.

In some embodiments, the display device includes an imager and a planar waveguide stack (i.e., a stack of planar waveguides). The imager generates an image based on light from a light source. The waveguide stack inputs light representing the image from the imager at an input surface and outputs the light representing the image toward an optical receptor of a user from an output surface. The term “optical receptor” as used herein means a human eye, an animal eye, or an optical sensor of a machine. The waveguide stack is mounted in a tilted manner so that when the near-eye display device is worn by the user or mounted near an optical receptor of the user, the output surface of the waveguide stack faces downward. The tilt angle of the waveguide stack and grating periods of diffraction optical elements of the waveguide stack serve to reduce ghost image effects and rainbow effects in the output images.

In some embodiments, a method for suppressing ghost image effects and rainbow effect includes: generating an image to be conveyed to an optical receptor of a user of a near-eye display device; coupling light representing the image into a planar waveguide stack at an input surface of the waveguide stack, and outputting, from the output surface of the waveguide stack, the light representing the image toward the optical receptor of the user. The waveguide stack is mounted in the near-eye display device in a tilted manner so that when the near-eye display device is worn by the user, an output surface of the waveguide stack faces downward and toward the optical receptor of the user.

Other aspects of the technique will be apparent from the accompanying figures and detailed description.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 shows an example of a near-eye display device that may incorporate the technique introduced herein.

FIG. 2 shows a side view of display components that may be contained within the near-eye display device of FIG. 1.

FIG. 3 shows an example of a waveguide to convey light to an eye of the user.

FIG. 4 shows a diffractive optical element coupling incident light into discrete diffraction orders with light paths of different directions.

FIG. 5A shows an example of a waveguide that has a regular tilt angle in a near-eye display device.

FIG. 5B shows an example of a waveguide that has an opposite tilt angle in a near-eye display device.

FIG. 6 shows a single layer of a waveguide placed at a regular tilt angle.

FIG. 7A shows two layers of waveguides placed at a regular tilt angle that may introduce ghost images at in-coupler ends.

FIG. 7B shows k-vector space representation of light beams of various diffraction orders travelling through in-couplers of waveguides placed at a regular tilt angle.

FIG. 7C shows two layers of waveguides placed at a regular tilt angle that may introduce ghost images at out-coupler ends.

FIG. 7D shows k-vector space representation of light beams of various diffraction orders travelling through out-couplers of waveguides placed at a regular tilt angle.

FIG. 8A shows two waveguides placed at an opposite tilt angle that suppress ghost image effect at in-coupler ends.

FIG. 8B shows k-vector space representation of light beams of diffraction orders travelling through waveguides placed at an opposite tilt angle without causing ghost images at in-coupler ends.

FIG. 8C shows two waveguides placed at an opposite tilt angle that suppress ghost image effect at out-coupler ends.

FIG. 8D shows k-vector space representation of light beams of diffraction orders travelling through waveguides placed at an opposite tilt angle without causing ghost images at out-coupler ends.

FIG. 9A shows ambient light travelling through a waveguide placed at a regular tilt angle and introduction of a rainbow effect.

FIG. 9B shows ambient light travelling through a waveguide placed at an opposite tilt angle and suppression of a rainbow effect.

FIG. 10A shows diffraction of external light incident at 60 degrees from upward into diffracted light beams of different colors through a waveguide placed at a regular tilt angle.

FIG. 10B shows diffraction of external light incident at 60 degrees from upward into diffracted light beams of different colors through a waveguide placed at an opposite tilt angle.

FIG. 11A shows diffraction of external light incident at 60 degrees from downward into diffracted light beams of different colors through a waveguide placed at a regular tilt angle.

FIG. 11B shows diffraction of external light incident at 60 degrees from downward into diffracted light beams of different colors through a waveguide placed at an opposite tilt angle.

FIG. 12 illustrates an example of a method of suppressing diffraction orders that cause ghost image effect and rainbow effect in a near-eye display device.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments referred to also are not necessarily mutually exclusive.

Some near-eye AR display devices include one or more output waveguides stacked together. For example, an RGB based display device may include three stacked output waveguides for each eye, e.g., one tuned to propagate red light, one tuned to propagate green light, and one tuned to propagate blue light. Each output waveguide can include one or more diffraction optical elements (DOEs) designed to guide light of a particular range of wavelengths to propagate within and through the waveguide via diffraction. The DOEs split the light into light beams of different diffraction orders and in different directions. Typically, the groove profiles of the DOEs are designed such that a desired diffraction order retains a substantial portion of the light energy. The process of designing groove profiles to control the distribution of light energy is referred to as “blazing”. The desired diffraction order is guided toward an optical receptor of a user (e.g., a human eye) for perceiving a main image. In other words, the output surface of the waveguide 600 faces upward and toward the optical receptor 660.

However, diffraction orders other than the desired diffraction order may exist and may be further diffracted. Since the diffraction process splits and changes the direction of the light beam (except the zero-th diffraction order), those undesired diffraction orders may be redirected via diffraction toward the optical receptor of the user. The optical receptor receives light of those undesired diffraction orders, and therefore, the user perceives ghost images super-imposed on the main image.

In an AR near-eye display devices, the output waveguides can be positioned so that their output surfaces (i.e., their surfaces facing and closest to the user's eye) are tilted slightly upward. This is done because the output waveguides with such a tilt angle can operate with DOEs having larger grating periods, which are easier and cheaper to manufacture. However, the inventors of the present invention have discovered that an opposite tilt angle of the output waveguides can serve to suppress ghost image effects. Hence, a near-eye AR display device such as introduced here includes waveguides that are placed at an opposite tilt angle, i.e., where output surfaces of the waveguides are angled downward. The output waveguides with the opposite tilt angle operates with smaller grating periods in order to guide light of the same wavelength. The combination of the opposite tilt angle and the smaller grating periods further causes light beams of different diffraction orders to be further spread out relative to each other. Thus, light beams of higher diffraction orders (i.e., higher than the desired diffraction order) are evanescent and have no chance of being redirected back toward the optical receptor of the user. Therefore, ghost images caused by undesired diffraction orders are significantly suppressed.

Moreover, the opposite tilt angle and the smaller grating periods also suppress rainbow effects from ambient light. With the opposite tilt angle and the smaller grating periods, the split light beams are further spread out relative to each other and have much less chance to reach the optical receptor of the user and to be perceived as a rainbow effect.

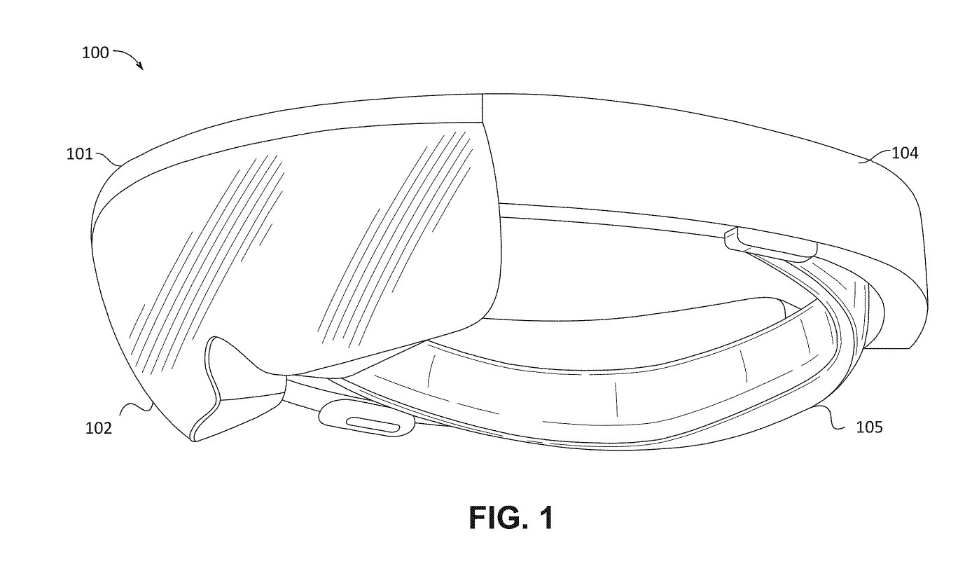

FIG. 1 shows an example of a near-eye display device in which the technique introduced here can be incorporated. The near-eye display device 100 may provide virtual reality (VR) and/or augmented reality (AR) display modes for the user, i.e., the wearer of the device. To facilitate description, it is henceforth assumed that the near-eye display device 100 is designed for AR visualization.

In the illustrated embodiment, the near-eye display device 100 includes a chassis 101, a transparent protective visor 102 mounted to the chassis 101, and left and right side arms 104 mounted to the chassis 101. The visor 102 forms a protective enclosure for various display elements (not shown) that are discussed below.

The chassis 101 is the mounting structure for the visor 102 and side arms 104, as well as for various sensors and other components (not shown) that are not germane to this description. A display assembly (not shown) that can generate images for AR visualization is also mounted to the chassis 101 and enclosed within the protective visor 102. The visor assembly 102 and/or chassis 101 may also house electronics (not shown) to control the functionality of the display assembly and other functions of the near-eye display device 100. The near-eye display device 100 further includes an adjustable headband 105 attached to the chassis 101, by which the near-eye display device 100 can be worn on a user's head.

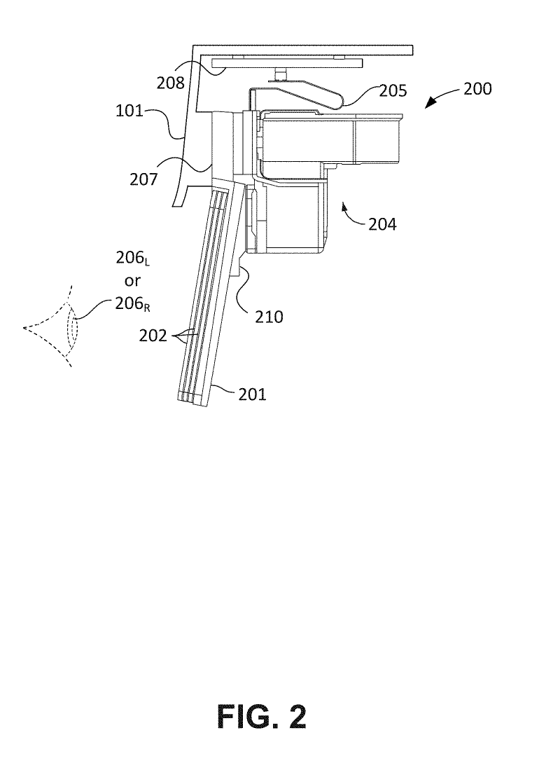

FIG. 2 shows, in accordance with certain embodiments, a side view of display components that may be contained within the visor 102 of the near-eye display device 100. During operation of the near-eye display device 100, the display components are positioned relative to the user's left eye 206_{L} or right eye 206_{R}. The display components are mounted to the interior surface of the chassis 101. The chassis 101 is shown in cross-section in FIG. 2.

The display components are designed to overlay three-dimensional images on the user's view of his real-world environment, e.g., by projecting light into the user's eyes. Accordingly, the display components include a display module 204 that houses a light engine including components such as: one or more light sources (e.g., one or more light emitting diodes (LEDs)); one or more microdisplay imagers, such as liquid crystal on silicon (LCOS), liquid crystal display (LCD), digital micromirror device (DMD); and one or more lenses, beam splitters and/or waveguides. The microdisplay imager(s) (not shown) within the display module 204 may be connected via a flexible circuit connector 205 to a printed circuit board 208 that has image generation/control electronics (not shown) mounted on it.

The display components further include a transparent waveguide carrier 201 to which the display module 204 is mounted, and multiple transparent output waveguides 202 stacked on the user's side of the waveguide carrier 201, for each of the left eye and right eye of the user. The waveguide carrier 201 has a central nose bridge portion 210, from which its left and right waveguide mounting surfaces extend. Multiple waveguides 202 are stacked on each of the left and right waveguide mounting surfaces of the waveguide carrier 201, to project light emitted from the display module and representing images into the left eye 206_{L} and right eye 206_{R}, respectively, of the user. The display assembly 200 can be mounted to the chassis 101 through a center tab 207 located at the top of the waveguide carrier 201 over the central nose bridge section 210.

The near-eye display device can provide light representing an image to an optical receptor of a user. The user may be, e.g., a human user of the near-eye display device or a machine attached to the near-eye display device.

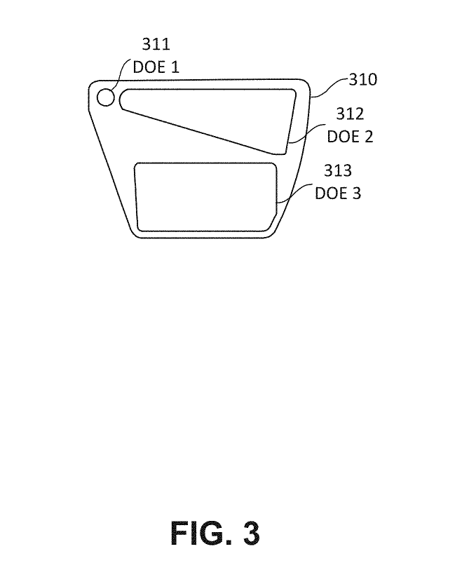

FIG. 3 shows an example of an output waveguide that can be mounted on the waveguide carrier 201 to convey light to an eye of the user. A similar waveguide can be designed for the left eye, for example, as a (horizontal) mirror image of the waveguide shown in FIG. 3. The waveguide 310 is transparent and, as can be seen from FIG. 2, would normally be disposed directly in front of the right eye of the user during operation of the near-eye display device, e.g., as one of the waveguides 202 in FIG. 2. The waveguide 310 is, therefore, shown from the user's perspective during operation of the near-eye display device 100. In some alternative embodiments, the waveguide 310 can be disposed in front of both the left eye and right eye of the user during operation of the near-eye display device.

The waveguide 310 includes a single input port 311 (also called in-coupling element) located in the region of the waveguide 310 that is closest to the user's nose bridge when the near-eye display device 100 is worn by the user. The input port 311 may be formed from, for example, a surface diffraction grating, volume diffraction grating, or a reflective component. The waveguide 310 further includes a single output port 313 (also called out-coupling element) and a transmission channel 312. A right-eye output port of the display module 204 (not shown) is optically coupled (but not necessarily physically coupled) to the input port 311 of the waveguide 310. During operation, the display module 204 (not shown) outputs light representing an image for the right eye from its right-eye output port into the input port 311 of the waveguide 310.

The transmission channel 312 conveys light from the input port 311 to the output port 313 and may be, for example, a surface diffraction grating, volume diffraction grating, or a reflective component. The transmission channel 312 may be designed to accomplish this by use of total internal reflection (TIR). Light representing the image for the right eye is then projected from the output port 313 to the user's eye.

The waveguide 310 may include multiple diffraction optical elements (DOEs), in order to control the directions of the light propagating in the near-eye display device via multiple occurrences of optical diffraction. The DOEs may be, e.g., surface diffraction gratings or volume diffraction gratings. Various components of the waveguide 310 can be designed to contain one or more of the DOEs.

For example, the waveguide 310 may include three DOEs. The input port 311 of the waveguide 310 is a DOE 1 for coupling light into the waveguide 310 and controlling the direction of light path after the light reaches the input port 311. The transmission channel 312 of the waveguide 310 is a DOE 1 for controlling the direction of light path in the transmission channel 312 and ensuring the light propagating inside of the transmission channel 312 through total internal reflection (TIR). The output port 313 is a DOE 3 for controlling the direction of the light path after the light exits the output port 313.

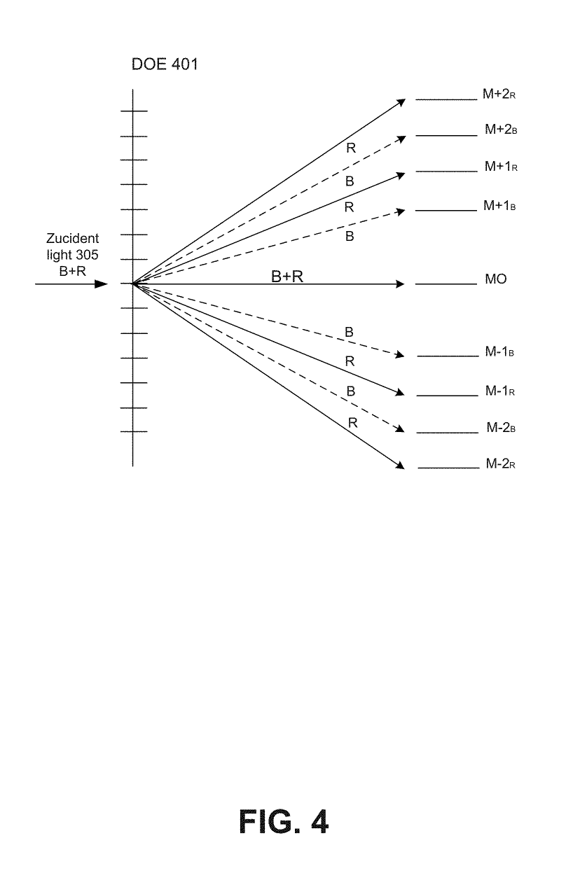

Due to the periodic nature of diffractive optical elements, the incident light is coupled into discrete diffraction orders, whenever the light travels through a DOE such as a diffraction grating. FIG. 4 shows that a diffractive optical element couples incident light into discrete diffraction orders with light paths of different directions. The incident light 405 includes light of two different colors blue (B) and red (R). In other words, the incident light 405 includes light of two different wavelengths (or two different ranges of wavelengths). As shown in FIG. 4, the output light on the right side of DOE 401 is split into multiple light rays in different directions. The directions of the light rays depend on the diffraction orders and the wavelengths.

The diffracted angles of the diffraction orders are governed by the grating equation,

$${θ}_{m} = arcsin ( \frac{m λ}{d} - sin {θ}_{i} ) .$$

Integer m represents the propagation mode, i.e., the diffraction order. Integer m can be 0, +1, −1, +2, −2, . . . , etc. Angle θₘ is the angle of the diffracted light of order m. Angle θ is the angle of the incident light, which is zero if the incident light 405 is normally incident on the surface of the DOE 401. Wavelength λ depends on the color of the light. For instance, red light has a longer wavelength λ than blue light. Grating period d is the distance between two adjacent grating lines of DOE 401 and is an intrinsic property of the grating pattern of DOE 401.

As shown in FIG. 4, the zero-th order diffraction light beam M0 still follows the direction of the incident light 405, and contains both the red and blue light. Light beams of other diffraction orders have different directions. The light beams of diffraction orders of positive integers are on the top side of the zero-th order light beam M0. The light beams of diffraction orders of negative integers are on the bottom side of the zero-th order light beam M0.

Light beams of higher diffraction orders are more deviated from the light beam of zero-th diffraction order. For example, the red light beam of −1 diffraction order M-1R is closer to the zero-th order beam M0, than the red light beam of −2 diffraction order M-2R.

According to the grating equation, the beam angles of the diffraction orders can be controlled by the grating period d. For example, by increasing or decreasing the grating period d between the adjacent diffraction grooves of the diffraction grating, the beam angles of the diffraction orders can be adjusted. Furthermore, the light energy distribution among the diffraction orders depends on the shape of the diffraction grooves. In other words, by adjusting the cross-sectional profile of the diffraction grooves, it is possible to concentrate most of the diffracted light energy in a particular diffraction order for a given wavelength. For example, by adjusting the groove profile, most of the light energy for the blue light may be concentrated on the blue light beam of −1 diffraction order M-1B.

Besides adjusting the diffraction pattern of DOEs, the light paths within the near-eye display device can further be adjusted by changing a tilt angle. As shown in FIG. 3, the near-eye display device uses one or more waveguides with multiple DOEs to achieve a desired light path through various diffraction orders. Those waveguides (e.g. waveguides 202 as illustrated in FIG. 2) are placed at a tilt angle. Depending on the tilt angle of the waveguides, certain diffraction effects, such as ghost effects or rainbow effects, can be achieved or avoided.

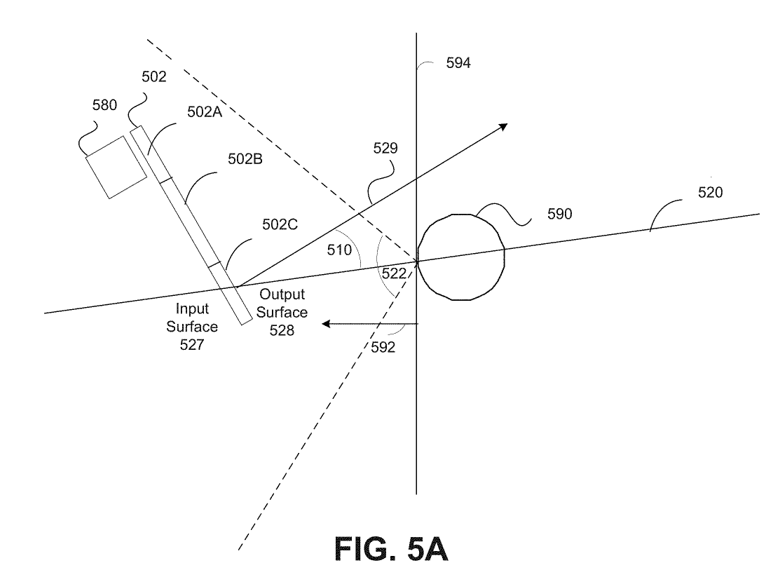

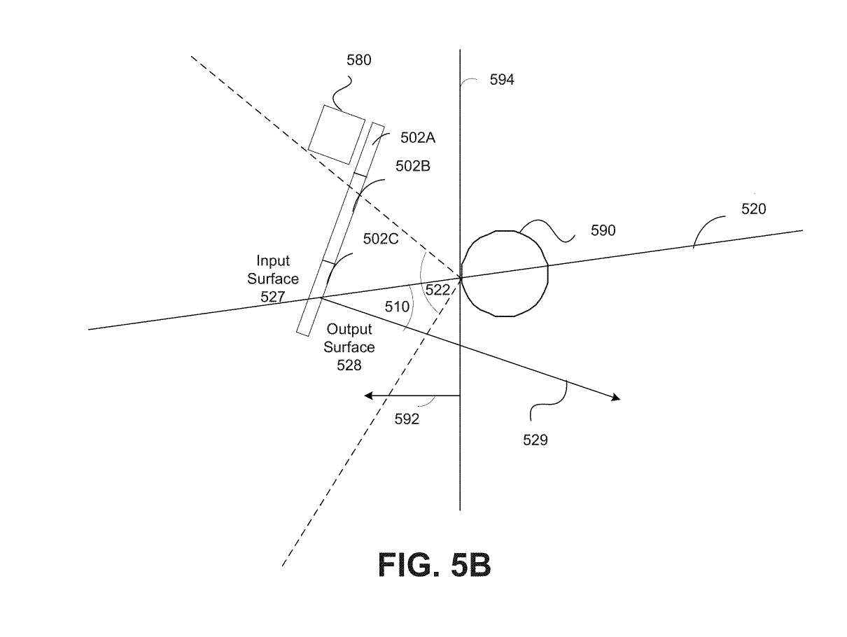

FIG. 5A shows an example of a regular tilt angle of an output waveguide of a near-eye display device in relation to an optical receptor. When a user wears the near-eye display device, the optical receptor 590 of the user has a field of view (FOV) 522 as illustrated in FIG. 5A. Line 520 is a center line of the field of view 522 and is also referred to as FOV center line 520. The FOV center line 520 represents an optical axis of the display module of the near-eye display device.

The FOV center line 520 does not necessarily in parallel with a true horizontal line, even when the user is standing or sitting straight. Because humans generally are most comfortable looking downwards at about 5 degrees, the FOV 522 is no in parallel with a true horizontal line, as shown in FIG. 5A. Here, the term “downwards” is defined relative to the head-pointing vector of a person and not the ground or floor in the user's environment. A person's head-pointing vector is defined here as a vector pointing in the direction that the front of the person's forehead faces (which can be, but is not always, parallel to their line of sight). Hence, “downwards” in this context may be different when a person is lying down than when sitting or standing.

The waveguide 502 and the imager 580 are placed in front of the optical receptor 590. The optical signals from the imager 528 propagate into an in-coupler region 502A of the waveguide 502. The optical signals further propagate through a transmission region 502B of the waveguide 520 and then exit from an out-coupler region 502C of the waveguide 502 toward the optical receptor 590. The waveguide 502 has a planar shape and therefore has two surfaces 527 and 528. The surface to which the imager 580 is optically coupled is called the input surface 527; the surface closest to the optical receptor 590 is called the output surface 528. The output surface 528 of waveguide 502 in FIG. 5A is tilted upwards.

As shown in FIG. 5A, a vector 529 is perpendicular to (“normal to”) the output surface 528 of the waveguide 502. The vector 529 originates from the output surface 528 at the same point where the FOV center line 520 passes through the output surface 528. The FOV center line 520 passes through the geometric center of an out-coupler region 502C of the waveguide 502. The tilt angle of the waveguide can be defined as the angle between the FOV center line 520 of the optical receptor 590 and the vector 529 normal to the output surface 528 of the waveguide 502, when the FOV center line 520 passes through the geometric center of the out-coupler region 502C of the waveguide 502.

FIG. 5B shows an example of an opposite tilt angle of the output waveguide. Compared to the waveguide 502 illustrated in FIG. 5A, the output surface 528 of waveguide 502 in FIG. 5B is tilted downwards. Again, the tilt angle 510 of the waveguide 502 can be defined as the angle between the FOV center line 520 and the vector 529 normal to the output surface 528, when the FOV center line 520 passes through the geometric center of the out-coupler region 502C of the waveguide 502.

Differences between FIGS. 5A and 5B include the locations of normal vector 529 and the in-coupler region 502A of the waveguide 502, relative to the optical receptor 590. The waveguide 502 includes an in-coupler region 502A that receives the optical signals from the imager 580, and an out-coupler region 502C that outputs the optical signals toward the optical receptor 590. When the user maintains a vertically neutral line of sight (e.g., not intentionally looking up or down), the FOV center line 520 passes through a geometric center of the out-coupler region 502C of the waveguide 502.

Furthermore, FIGS. 5A and 5B show a head-pointing vector 592, which is defined above. When the user maintains a vertically neutral line of sight, the FOV center line 520 may be parallel to the head-pointing vector 592. FIGS. 5A and 5B further show a receptor plane 594. The receptor plane 594 is perpendicular to the head-pointing vector 592 and passes through the front surface of the optical receptor 590.

As shown in FIG. 5A, the normal vector 529 and the in-coupler region 502A are on the same side of the FOV center line 520, when the FOV center line 520 passes through the geometric center of the out-coupler region 502C of the waveguide 502. The out-coupler region 502C of the waveguide 502 is closer to the receptor plane 594 than the in-coupler region 502A of the waveguide 502 is. An output waveguide having such a tilt angle as illustrated in FIG. 5A is said to have a regular tilt angle.

As shown in FIG. 5B, the normal vector 529 and the in-coupler region 502A are on two different sides of the FOV center line 520, when the FOV center line 520 passes through the geometric center of the out-coupler region 502C of the waveguide 502. The in-coupler region 502A of the waveguide 502 is closer to the receptor plane 594 than the out-coupler region 502C of the waveguide 502 is. An output waveguide having such a tilt angle as illustrated in FIG. 5B is said to have an opposite tilt angle.

In some embodiments, the opposite tilt angle of an output waveguide is within the range of 5 degrees to 45 degrees. In some other embodiments, the opposite tilt angle is in the range of 10 degrees to 40 degrees.

The corresponding grating period can be estimated by an equation of

$$d = \frac{λ}{n * sin ( {θ}_{p} ) - sin ( {θ}_{t} )} ;$$

where d is the grating period, λ is the wavelength of the light, n is the refractive index of waveguide material, θₜ is the angle of tilt angle of the waveguide. Tilt angle θₜ is positive for a regular tilt angle; tilt angle θₜ is negative for an opposite tilt angle. θₚ is the desired light propagation angle (with respect to the nominal line) inside of the waveguide before the light arrives the out-coupler region. θₚ may be around 50 degrees if a field of view is around 35 degrees for a waveguide material with a refractive index n=1.7.

For example, the waveguide may be optimized for green light with a wavelength of 525 nm (nanometer) and the waveguide material has a refractive index n=1.7. For a regular tilt angle θₜ of 15 degrees, the grating period d is about 500 nm; for an opposite tilt angle θₜ of −15 degrees, the grating period d is about 340 nm. For a regular tilt angle θₜ of 10 degrees, the grating period d is about 470 nm; for an opposite tilt angle θₜ of −10 degrees, the grating period d is about 360 nm. For a regular tilt angle θₜ of 5 degrees, the grating period d is about 430 nm; for an opposite tilt angle θₜ of −5 degrees, the grating period d is about 380 nm. Therefore, waveguides placed at opposite tilt angles may have smaller grating periods, compared to waveguides placed at regular tilt angles.

Ghost Effects at in-Coupler Ends

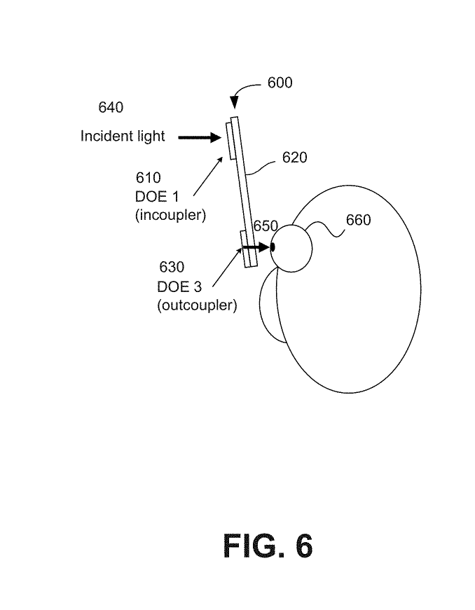

Depending on whether the tilt angle of the waveguide is regular or opposite, ghost effects due to optical diffraction can be enhanced or suppressed. FIG. 6 shows a single waveguide placed at a regular tilt angle. The waveguide 600 includes an in-coupler (also referred to as input port) DOE 610, an expander DOE 620, and an out-coupler (also referred to as output port) DOE 630. The waveguide 600 can be part of a near-eye display device such as illustrated in FIG. 2.

The waveguide 600 is planar and has two sides. The waveguide 600 receives the incident light 640 at the left side (the input surface), and outputs the light 650 at the right side (the output surface) to an optical receptor 660. The optical receptor 660 may be, e.g., a human eye, an animal eye, or an optical sensor of a machine. The waveguide 600 has a regular tilt angle. In other words, the output surface of the waveguide 600 faces upward and toward the optical receptor 660.

The tilt angle, the grating periods and the groove profiles of the waveguide and DOEs 610, 620 and 630 can be optimized for a particular wavelength. Therefore, incident light 640 at the particular wavelength can be guided through the waveguide (e.g., by TIR) and output as light 650 without introducing any ghost effect.

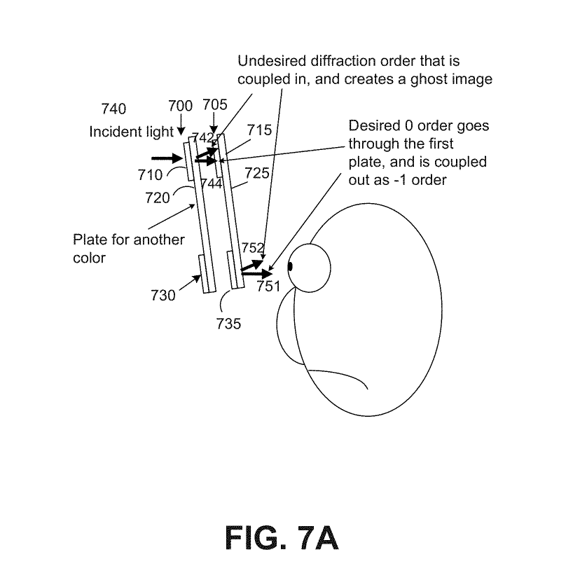

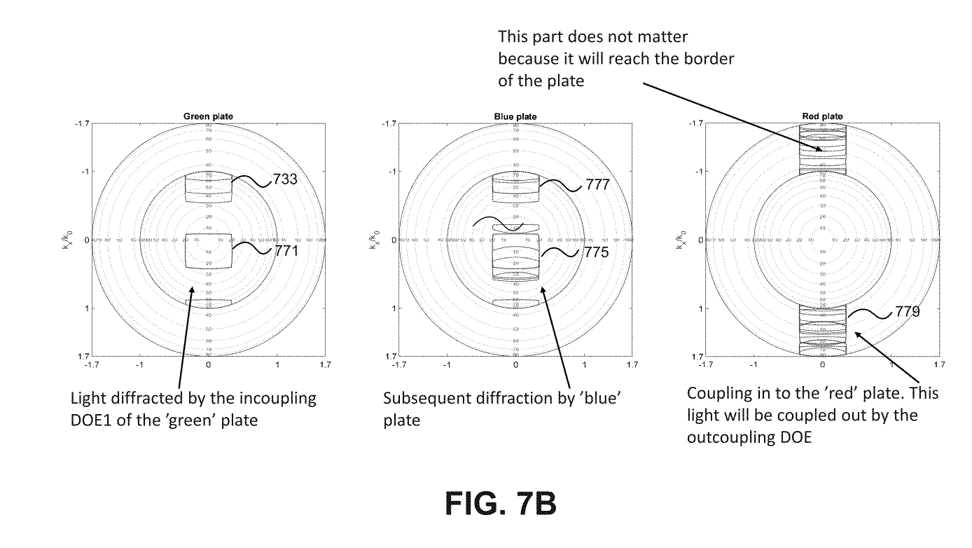

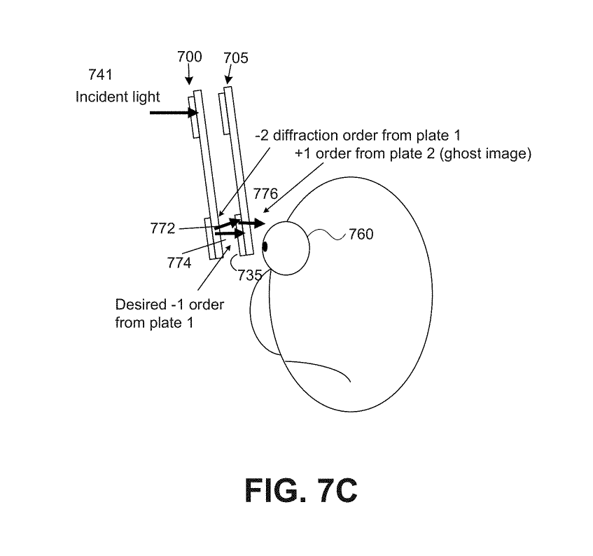

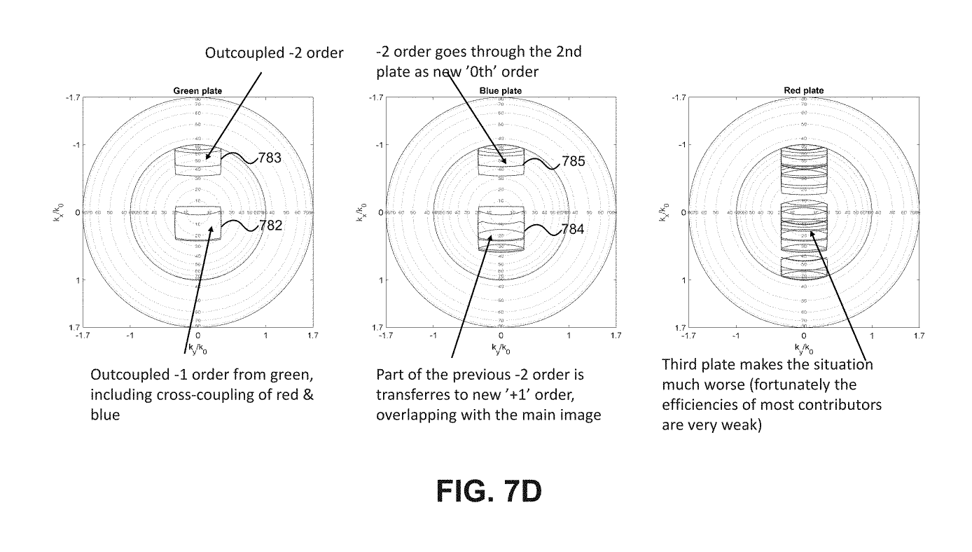

In contrast, multiple layers of waveguides can introduce ghost effect due to diffraction of light beams of different wavelengths. FIG. 7A shows two layers of waveguides placed at a regular tilt angle that may introduce ghost images. Those two layers of waveguides 700 and 705 are respectively optimized to guide light beams of different wavelengths (thus, different colors). The technology disclosed herein can be used to guide light beams of any wavelengths. For ease of discussion, the waveguide 700 is assumed to be optimized to guide green (G) light; the waveguide 705 is assumed to be optimized to guide blue (B) light. The waveguides 700 and 705 can be part of a near-eye display device as illustrated in FIG. 2.

Similar to the waveguide 600, the waveguides 700 and 705 have a regular tilt angle. In other words, the output surfaces of the waveguides 700 and 705 face slightly upward the optical receptor 760. Each of the waveguides 700 and 705 have three DOEs, like the waveguide 600.

The waveguides 700 and 705 are optimized for different colors green and blue. Waveguide 700 is designed to receive (also referred to as “couple in” or “in-couple”) green light at in-coupler 710 and to output (also referred to as “couple out” or “out-couple”) the green light at out-coupler 730. Waveguide 705 is designed to receive blue light at in-coupler 715 and to output the blue light at out-coupler 735.

Since waveguides 700 and 705 are stacked together as shown in FIG. 7A, the blue light, which is designed to be coupled into waveguide 705, needs to travel through waveguide 700 before the blue light can reach waveguide 705. As shown in FIG. 7A, when the light 740 travels through waveguide 700, the light experiences diffraction by the DOE of the in-coupler 710 (which is optimized for green light) and is split into at least two light beams 742 and 744 with different diffraction orders. The light beam 744 with zero diffraction order is a desired since the light beam 744 maintains the same direction as the original incident blue light 740.

The light beam 742 with non-zero diffraction order is an undesired, because such a beam of non-zero diffraction order reaches the in-coupler 715 of waveguide 705 at a non-optimized angle. Once the light beams 742 and 744 enter the waveguide 705, those beams propagate within the waveguide 705 and exit at out-coupler 735, as light beams 752 and 754 respectively. Those light beams 752 and 754 have different diffraction orders and different directions. Particularly, the light beam 752 has an undesired direction and causes ghost image. Because the ghost image is caused by diffraction at in-coupler (DOE 1), the ghost image effect by the light beam 752 is also called DOE 1 ghost effect.

The travelling directions of light beams of different diffraction orders can be explained by a k-vector space representation. FIG. 7B shows k-vector space representation of light beams of various diffraction orders travelling through in-couplers of waveguides placed at a regular tilt angle. The waveguides of FIG. 7B have three layers: the first waveguide optimized for green light, the second waveguide optimized for blue light, and the third waveguide optimized for red light.

The left, middle, right k-vector space graphs of FIG. 7B respectively show the field of view of diffraction orders diffracted by the in-coupler of the first waveguide, the second waveguide and the third waveguide. In each k-vector space graph, any light waves in the doughnut shaped portion between two concentric circles propagate in the waveguide by total internal reflection (TIR). Any light waves in the inner circle are waves propagate in the air and the waveguide. In other words, those light waves are coupled into the waveguide and then exit from the waveguide. Any light waves outside of the outer circle are evanescent waves that are not coupled into the waveguide.

Turning to the left graph of FIG. 7B showing diffraction by the in-coupler of the first waveguide, area 771 in the middle of the inner circle represents the desired −1 diffraction order, which contributes to the main image. Area 773 in the upper portion of the inner circle represents a −2 diffraction order, which exits the first waveguide at a large angle. Both light beams represented by the area 771 (−1 diffraction order) and area 773 (−2 diffraction order) enters the second waveguide and are further diffracted by the in-coupler of the second waveguide.

The middle graph of FIG. 7B shows diffraction by the in-coupler of the second waveguide. The light beam of area 771 (−1 diffraction order of the first waveguide) again exits the second waveguide and contributes to the light represented by the area 775, which is in the middle of the inner circle of the middle graph. Thus, the light of area 775 includes light of the main image.

Moreover, the light beam of area 773 (−2 diffraction order of the first waveguide) is also diffracted and split into different diffraction orders, including the 0 order represented by the area 777 and the +1 order represented by the area 775. The light of the area 777 (0 diffraction order) exits the waveguide at a large angle. The light of +1 order belongs to the light of the area 775, which also includes the light of the main image. Therefore, the light of the main image and the light of the ghost image are mixed together in the area 775.

The light further enters the third waveguide at the in-coupler and exits from the out-coupler of the third waveguide. The right graph of FIG. 7B shows the diffraction by the third waveguide. Because the light needs to propagate inside of the third waveguide, including the transmission channel portion of the third waveguide, the area 779 including the desired light is inside of the doughnut portion of the k-vector space graph.

Since the area 775 already includes a mixture of light of the main image and the light of the ghost image, the area 779 of the third waveguide also includes a mixture of the light of the main image and the light of the ghost image. As shown in the right graph of FIG. 7B, even more diffraction orders are introduced to the area 775, which further enhances the ghost image effect.

### Ghost Effects at Out-Coupler Ends

Beside the ghost image caused by the light beam 752 in FIG. 7A, the waveguides 700 and 705 also may introduce ghost images caused by the diffraction at the out-coupler end. FIG. 7C shows the same waveguides 700 and 705. The incident light 741 first reaches waveguide 700 and propagates through waveguide 700 as designed.

The waveguide 700 outputs at least two light beams 772 and 774 of different diffraction orders. The light beam 774 has a direction toward the optical receptor 760 and is of a desired diffraction order (e.g., −1 order). On the other hand, the light beam 772 has a direction not toward the optical receptor 760 and is of an undesired diffraction order (e.g., −2 order).

After leaving waveguide 700, the light beams 772 and 774 further travels through waveguide 705. The light beam 772 is further split into beams of different diffraction orders when travelling through out-coupler 735 of waveguide 705. Those beams of different diffraction orders have different directions. Among them, a light beam 776 of a diffraction order of +1 has a direction toward the optical receptor 760. Therefore, the light beam 776 overlaps with desired light beam and causes ghost image. Because the ghost image is caused by diffraction at out-coupler 735 (also referred to as DOE 3), the ghost image effect by the light beam 776 is also called DOE 3 ghost effect.

The DOE 3 ghost effect can also be explained in a k-vector space representation. FIG. 7D shows k-vector space representation of light beams of various diffraction orders travelling through out-couplers of waveguides placed at a regular tilt angle. The waveguides have three layers: the first waveguide optimized for green light, the second waveguide optimized for blue light, and the third waveguide optimized for red light.

The left, middle, right k-vector space graphs of FIG. 7D respectively show the field of view of diffraction orders diffracted by the out-coupler of the first waveguide, the second waveguide and the third waveguide. In each k-vector space graph, any light waves in the doughnut shaped portion between two concentric circles propagate in the waveguide by total internal reflection (TIR). Any light waves in the inner circle are waves propagate in the air and the waveguide. In other words, those light waves are coupled into the waveguide and then exit from the waveguide. Any light waves outside of the outer circle are evanescent waves that are not coupled into the waveguide.

Turning to the left graph of FIG. 7D showing diffraction by the out-coupler of the first waveguide, the area 782 in the middle of the inner circle represents the light exit from the out-coupler toward the optical receptor and contributes to the main image. The light of area 782 includes the green light of diffraction order −1, as well as cross-coupled red and blue light. Area 783 on the top section of the inner circle represents the light of diffraction order of −2. The −2 diffraction order light also exits from the out-coupler but does not travel toward the optical receptor.

Now turning to the middle graph of FIG. 7D showing diffraction by the out-coupler of the second waveguide, the area 784 in the middle of the inner circle include main image light that is from the area 782. Furthermore, the out-coupled −2 order light from area 783 is further split into a new zero order beam and a new +1 order beam. The zero order beam is in the area 785 and does not overlap with the main image. However, the new +1 order beam is also in the same area 784, and therefore overlaps with the main image. The optical receptor will receive those new +1 order beam and perceive a ghost image overlapping with the new image.

The left graph of FIG. 7D shows diffraction by the out-coupler of the third waveguide. More light beams of higher orders will reach the central area and overlap with the light of the main image. Thus, after the diffraction of the third waveguide, more ghost images will be introduced.

Therefore, as shown in FIGS. 7A-7D, multiple layers of waveguides placed at a regular tilt angle can introduce ghost images due to light beams of higher diffraction orders reaching the optical receptor and overlapping with light of the main image. Those ghost images can be suppressed by placing the multiple layers of waveguides at an opposite tilt angle.

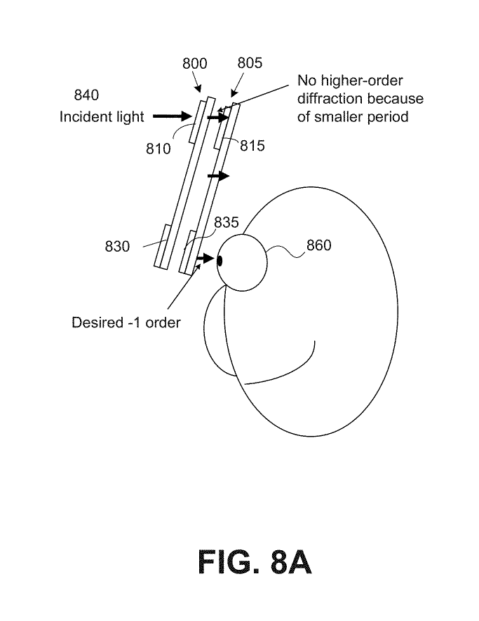

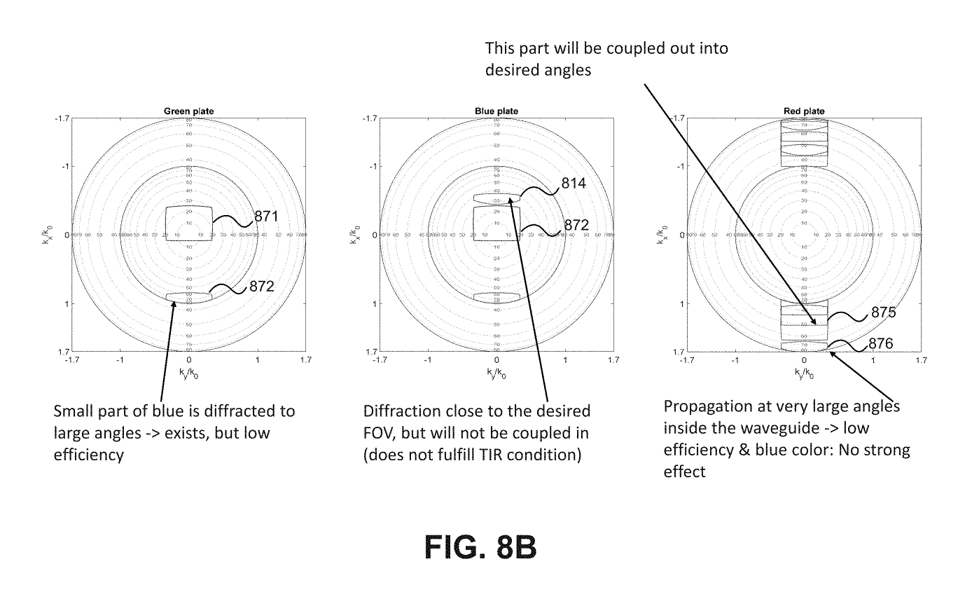

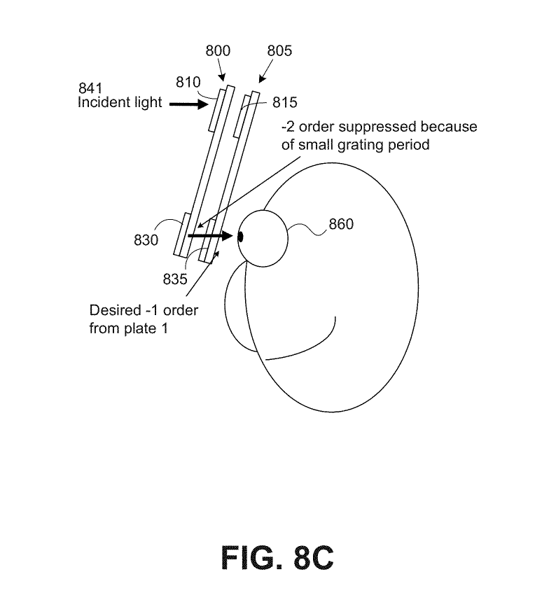

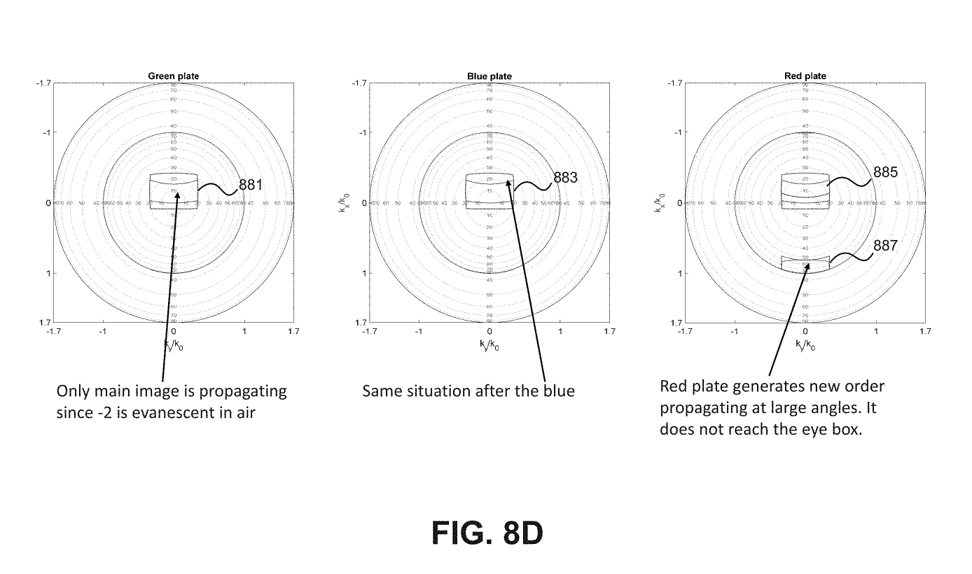

FIG. 8A shows waveguides 800 and 805 placed at an opposite tilt angle that suppress ghost image effect. Multiple planar waveguides stacked together, such as waveguides 800 and 805, can be collectively called a planar waveguide stack. Such an opposite tilt angle leads to a small grating period for the DOEs in order to couple the desired −1 diffraction order light to propagate inside the waveguide. When the opposite tilt angle is sufficiently large and the grating periods are sufficiently small, the higher diffraction orders are suppressed. Consequently, ghost image effects are significantly reduced because of the suppressed higher diffraction orders.

The incident light 840, shown in FIG. 8A, enters the waveguide 800 at the in-coupler 810. Some of the incident light 840, particularly the light of wavelengths, for which the waveguide 800 is not optimized, exits directly from the in-coupler 810 instead of out-coupler 830. The light is diffracted by the in-coupler 810. As shown later in FIG. 8B, Only the desired −1 diffraction order exits the in-coupler 810.

The light then enters the in-coupler 815 of the waveguide 805 at the proper angle. The light propagates through the waveguide 805 and exits from the out-coupler 835 as the desired −1 diffraction order. The light beam of −1 diffraction eventually reaches the optical receptor 860 and contributes to the main image.

The k-vector space representation in FIG. 8B confirms that the opposite tilt angle and small grating period suppress the ghost effect. The left graph of FIG. 8B shows the diffraction orders diffracted by the in-coupler of the first waveguide. The area 871 in the middle of the inner circle represents the −1 diffraction order, which contributes to the main image. The small area 872 represents another diffraction order that travels at a large angle and has a low efficiency.

The middle graph of FIG. 8B shows the diffraction by the in-coupler of the second waveguide. Similar to the situation in the left graph, the area 873 in the middle of the inner circle represents the desired −1 diffraction order. The area 873 is in the desired field of view (FOV) for reaching the optical receptor and for contributing to the main image. The area 874 is a diffraction order close to the desired field of view. However, the light represented by area 874 will not be coupled in because its propagating angle does not fulfil the condition of total internal reflection (TIR).

The light further enters the third waveguide at the in-coupler and exits from the out-coupler of the third waveguide, instead of the in-coupler of the third waveguide. The right graph of FIG. 8B shows the diffraction by the third waveguide. Because the light needs to propagate inside of the third waveguide, including the transmission channel portion of the third waveguide, the area 875 representing the desired light is inside of the doughnut portion of the k-vector space graph.

The area 876 represents light originally from diffraction order of area 872. Although the light of area 876 also exits from the out-coupler of the third waveguide, the light of area 876 exits at a large angle. The light of area 876 also has a low efficiency. Therefore, the light of area 876 will not introduce a ghost image that can be perceived by the optical receptor. Hence, the ghost image effect is suppressed.

FIG. 8C shows the same waveguides 800 and 805 placed at an opposite tilt angle. Such an opposite tilt angle leads to a small grating period for the DOEs in order to couple −1 diffraction order light to propagate inside the waveguide. When the opposite tilt angle is sufficiently large and the grating periods are sufficiently small, the higher diffraction orders are suppressed. Consequently, ghost image effects are significantly reduced because of the suppressed higher diffraction orders.

As shown in FIG. 8C, the incident light 841 enters the waveguide 800 at the in-coupler 810. The light propagates inside of the waveguide 800 and a majority of the light exits at the out-coupler 830 as a light beam of −1 diffraction order. The light beam of −1 diffraction order is a desired light beam because it travels toward the optical receptor 860 and forms the main image. Because of the small granting period, the light beam of −2 diffraction order is evanescent and therefore suppressed. The light beam of −1 diffraction order further travels through the out-coupler 835 of waveguide 805 and eventually reaches the optical receptor 860.

The k-vector space representation in FIG. 8D confirms that the opposite tilt angle and small grating period suppress the ghost effect. The left graph of FIG. 8D shows the diffraction orders diffracted by the out-coupler of the first waveguide. The area 881 in the middle of the inner circle represents the −1 diffraction order, which contributes to the main image. There is no area shown in the left graph representing any −2 diffraction order. Thus, the −2 diffraction order is evanescent.

The middle graph of FIG. 8D shows the diffraction by the out-coupler of the second waveguide. Similar to the situation in the left graph, the area 883 in the middle of the inner circle represents the −1 diffraction order for the main image. Other diffraction orders are not shown and thus evanescent.

The light beam of −1 diffraction order then travels through the third waveguide. The right graph of FIG. 8D shows the diffraction by the out-coupler of the third waveguide. The area 885 in the middle of the inner circle represents the 01 diffraction order, which has a direction toward the optical receptor and contributes to the main image. Another area 887 inside of the inner circle represents another diffraction order exiting the third waveguide. However, the position of area 887 indicates that the light beam propagates at a large angle and does not reach the optical receptor. Therefore, only light contributing to the main image reaches the optical receptor. Hence, the ghost image effect is suppressed.

### Rainbow Effect Suppression

Besides the suppression of ghost image effects, the opposite tilt angle and the small grating period also can suppress the rainbow effect. As shown in FIG. 4, light having a wide spectrum can be diffracted into multiple diffraction orders. For a particular diffraction order, the light beams of different wavelengths are diffracted into different directions. In order words, the light beams of different wavelengths are spread out by diffraction. For example, the red light beam M-1R and the blue light beam M-1B are spread out relative to each other. This causes the rainbow effect that can be perceived by human eyes or other types of optical receptors.

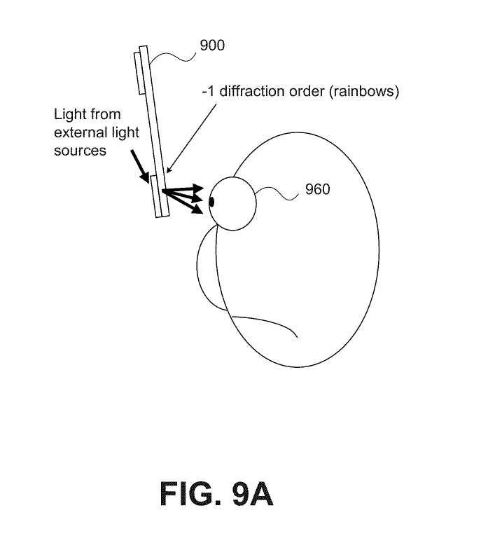

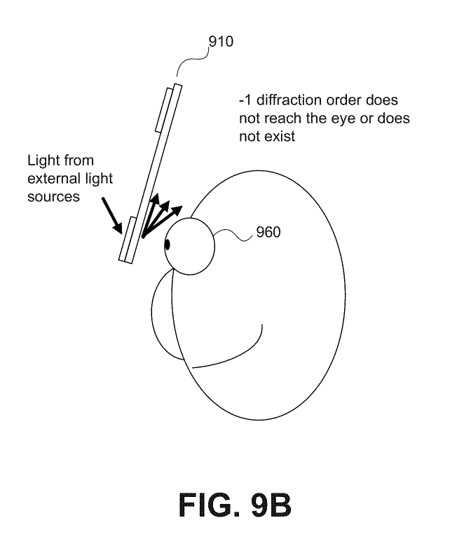

FIGS. 9A and 9B show that ambient light travels through a waveguide and a rainbow effect can be introduced or suppressed depending on the tilt angle of the waveguide. FIG. 9A shows a waveguide 900 placed at a regular tilt angle. Light source external from the near-eye display device emits ambient light that travels through the waveguide and reaches the optical receptor 960. The diffraction grating of the waveguide diffracts the ambient light and separate them into light beams of different colors. The diffracted light beams of different colors are still within the field of view for the optical receptor 960. Therefore, the optical receptor 960 can perceive the rainbow effect.

FIG. 9B shows a waveguide 910 placed at an opposite tilt angle. The diffraction gratings of the waveguide 910 have smaller grating periods than the diffraction

$${θ}_{m} = arcsin ( \frac{m λ}{d} - sin {θ}_{i} ) ,$$

gratings of the waveguide 900. According to the grating equation of the smaller grating period d leads to larger spread (also referred to as angular divergence) of beams of different colors, which reduces the rainbow effect. As shown in FIG. 9B, the diffracted light beams of different colors are outside of the field of view of the optical receptor 906. Therefore, the rainbow effect is substantially suppressed by the waveguide 910.

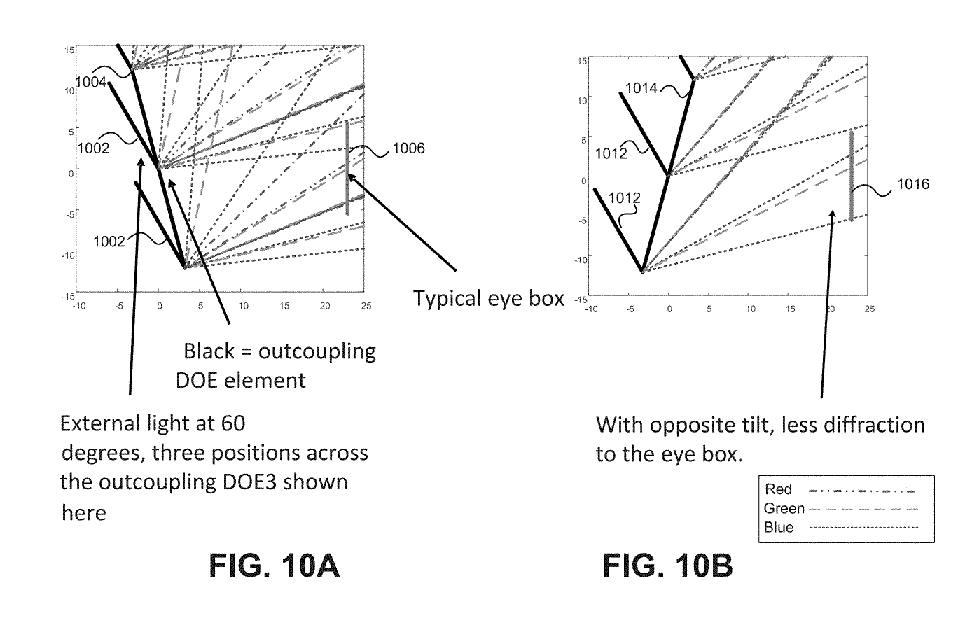

FIGS. 10A and 10B show that an external light incident at 60 degrees from upward is diffracted into diffracted light beams of different colors. The diffracted light beams are represented by different types of dashed lines in FIGS. 10A and 10B. FIG. 10A illustrates diffraction by a waveguide of a regular tilt angle of 15 degrees. In FIG. 10A, the lines 1002 represent the external light incident at 60 degrees (above the horizontal line) and reach the lines 1004, which represent the out-coupling DOE element of the waveguide (e.g., diffraction grating). The line 1006 represents an eye box, which is a region in which an optical receptor can be located. In other words, the optical receptor (e.g., human eye) can be smaller than the eye box and can be located anywhere within the eye box.

FIG. 10B illustrates diffraction by a waveguide of an opposite tilt angle of 15 degrees. The lines 1012 represent the external light incident at 60 degrees and reach the lines 1014, which represent the out-coupling DOE element of the waveguide (e.g., diffraction grating). The line 1016 represents an eye box, which is a region in which an optical receptor can be located. Comparing FIG. 10A with FIG. 10B, much less diffracted external light of different colors reaches the eye box 1016 due to the opposite tilt angle of 15 degrees. Therefore, the opposite tilt angle and smaller grating period help suppressing the rainbow effect.

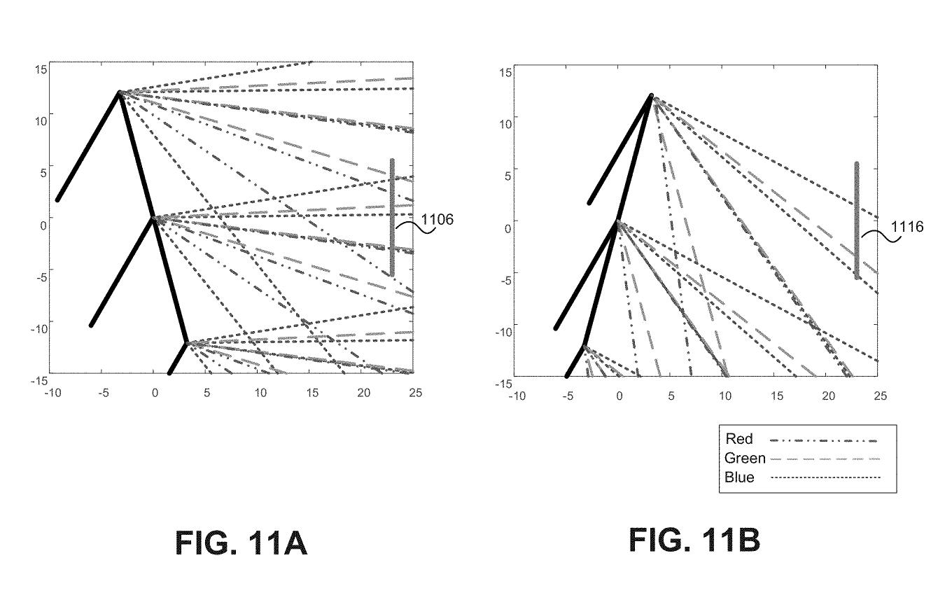

FIGS. 11A and 11B show that an external light incident at 60 degrees from downward is diffracted into diffracted light beams of different colors. Light sources of such an external light may be, e.g. floor lighting devices. FIG. 11A shows that through the waveguide of a regular tilt angle, lots of diffracted light beams of different colors (represented by different types of dashed lines) reach the eye box 1106. FIG. 11B shows that through the waveguide of an opposite tilt angle, much less diffracted light beams of different colors reach the eye box 1116. Therefore, again the opposite tilt angle and smaller grating period help suppressing the rainbow effect.

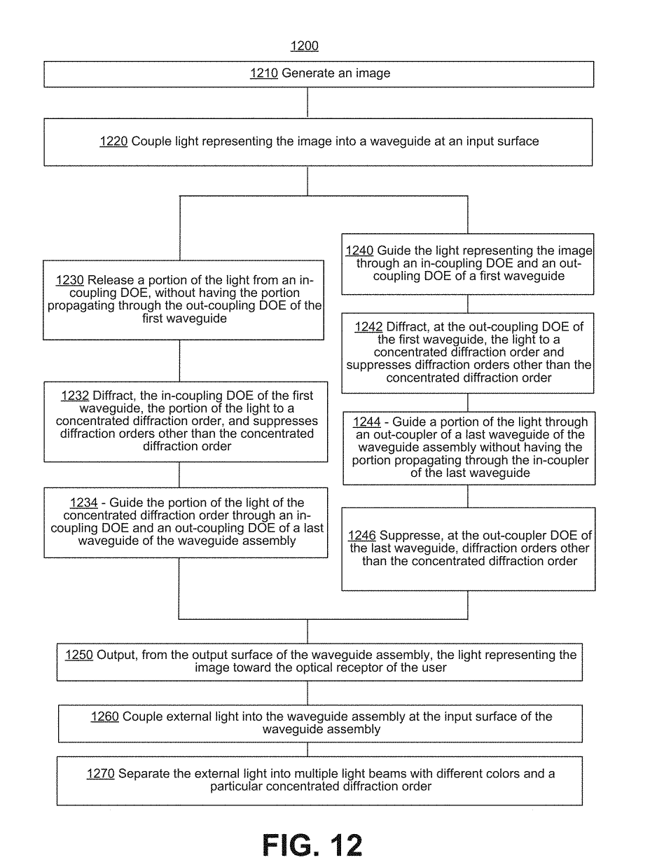

FIG. 12 illustrates an example of a method of suppressing diffraction orders that can cause ghost image effect and rainbow effect in a near-eye display device. The method 1200 begins at step 1210 where an imager of the near-eye display device generates an image to be conveyed to an optical receptor of a user of the near-eye display device. Next, at step 1220, the device couples light representing the image into a planar waveguide stack at an input surface of the waveguide stack. The waveguide stack is mounted in the near-eye display device in a tilted manner so that when the near-eye display device is worn by the user, an output surface of the waveguide stack faces partially downward, i.e., it has an opposite tilt.

Once the light enters into the waveguide stack, the propagating path of the light is split into multiple paths. Particularly, each waveguide within the waveguide stack is optimized to propagate light of a particular color. For light having a color corresponding to that waveguide, the light prorogates through all components of that waveguide. For light having colors not corresponding to that waveguide, the light travels directly across that waveguide (with diffraction effect), and exits from, for example, the back of an in-coupling DOE of the waveguide.

At step 1230, the device releases a portion of the light representing the image from an in-coupling DOE of a first waveguide of the waveguide stack, without having the portion of the light propagating through the out-coupling DOE of the first waveguide. In other words, that portion of the light directly travels across the first waveguide without propagating through all components of the first waveguide.

Further, at step 1232, the in-coupling DOE of the first waveguide diffracts the portion of the light to a concentrated diffraction order, and suppresses diffraction orders other than the concentrated diffraction order. At step 1234, the device guides the portion of the light of the concentrated diffraction order through an in-coupling DOE and an out-coupling DOE of a last waveguide of the waveguide stack and toward the optical receptor of the user.

Other portion of the light propagates in a light path different from the path of steps 1230, 1232 and 1234. At step 1240, the device guides the light representing the image through an in-coupling DOE and an out-coupling DOE of a first waveguide of the waveguide stack. In other words, that portion of the light propagates through all components of the first waveguide before exiting the first waveguide.

Next, at step 1242, the out-coupling DOE of the first waveguide diffracts the light to a concentrated diffraction order and suppresses diffraction orders other than the concentrated diffraction order. At step 1244, the device guides a portion of the light through an out-coupler of a last waveguide of the waveguide stack without having the portion of the light propagating through the in-coupler of the last waveguide.

At step 1246, the out-coupler DOE of the last waveguide suppresses diffraction orders other than the concentrated diffraction order such that the optical receptor receives no ghost image caused by the diffraction orders other than the concentrated diffraction order.

At step 1250, the waveguide stack outputs, from the output surface of the waveguide stack, the light representing the image toward the optical receptor of the user. The optical receptor receives the light representing the main image without a super-imposition of ghost images.

The near-eye display device further suppresses rainbow effect. At step 1260, the device couples external light (i.e., light not generated by the near-eye display device) into the waveguide stack at the input surface of the waveguide stack. Next, at step 1270, a diffraction optical element (DOE) of the waveguide stack separates the external light into multiple light beams with different colors and a particular concentrated diffraction order, wherein the DOE has a grating period such that the light beams with the different colors and the particular concentrated diffraction order do not reach the optical receptor of the user.

### EXAMPLES OF CERTAIN EMBODIMENTS

Certain embodiments of the technology introduced herein are summarized in the following numbered examples:

1. A near-eye display device including: an imager to generate an image based on light from a light source; and a first planar waveguide to input light representing the image from the imager at an in-coupler region of the first waveguide and to output the light representing the image from an out-coupler region of the first waveguide toward an optical receptor of a user, the first waveguide being mounted in the near-eye display device in a tilted manner so that the in-coupler region is closer than the out-coupler region to a receptor plane of the optical receptor of the user, the receptor plane of the optical receptor of the user being perpendicular to a head-pointing vector of the user and passing through a surface of the optical receptor of the user.

2. The near-eye display device of example 1, further including: a transparent waveguide carrier upon which the first waveguide is mounted.

3. The near-eye display device of example 1 or 2, further including: an additional second planar waveguide to input light representing a second image at an additional in-coupler region of the second waveguide and to output the light representing the second image toward a second optical receptor of the user from an additional out-coupler region of the additional waveguide, the additional waveguide being mounted in the near-eye display device in a tilted manner so that the additional in-coupler region is closer than the additional out-coupler region to the receptor plane.

4. The near-eye display device of any of examples 1 through 3, wherein the first waveguide includes a diffraction optical element (DOE) separating external light from an external light source into a plurality of light beams of different colors, the DOE has a grating period such that when the near-eye display device is worn by the user, some of the light beams of the different colors from the external light source do not reach the optical receptor of the user.

5. The near-eye display device of any of examples 1 through 4, wherein the first waveguide includes a diffraction optical element (DOE) for separating external light from an external light source into a plurality of light beams with different colors and different diffraction orders, the DOE has a groove profile for concentrating light energy in a particular diffraction order, the DOE has a grating period such that the light beam of the particular diffraction order and of the different colors do not reach the optical receptor of the user.

6. The near-eye display device of example 5, wherein the particular diffraction order is of −1 order that is a diffraction order next to the zero order, a light beam of the zero order does not change direction relative to the external light.

7. The near-eye display device of any of examples 1 through 6, further including: a second planar waveguide stacked together with the first waveguide such that an output surface of the first waveguide faces toward an input surface of the second waveguide, the first and second waveguides being stacked in the same tilted manner so that in-coupler regions of the first and second waveguides are closer than out-coupler regions of the first and second waveguides to the receptor plane of the optical receptor.

8. The near-eye display device of example 7, wherein each of the waveguides includes at least one diffraction optical element (DOE), the DOEs of the waveguides have diffraction groove profiles for concentrating light energy output by each of the waveguides in a particular diffraction order.

9. The near-eye display device of example 7 or 8, wherein each of the waveguides includes at least one diffraction optical element (DOE) for concentrating light energy in a particular diffraction order, the DOEs have diffraction grating periods such that diffraction orders other than the particular diffraction order are suppressed.

10. The near-eye display device of any of examples 7 through 9, wherein the first waveguide includes a first in-coupling diffraction optical element (DOE), a first transmission channel and a first out-coupling DOE, and wherein the second waveguide includes a second in-coupling DOE, a second transmission channel and a second out-coupling DOE; wherein a portion of the light representing the image exits from the first waveguide after propagating through the first in-coupling DOE and without propagating through the first transmission channel and the first out-coupling DOE of the first waveguide, the portion of the light further enters the second waveguide and propagates through the second in-coupling DOE, the second transmission channel and the second out-coupling DOE of the second waveguide before reaching the optical receptor of the user; and wherein the portion of the light is diffracted by the first in-coupling DOE of the first waveguide into a concentrated diffraction order, and the first in-coupling DOE of the first waveguide has a diffraction grating period such that light of all diffraction orders other than the concentrated diffraction order are suppressed.

11. The near-eye display device of any of examples 7 through 10, wherein the first waveguide includes a first in-coupling diffraction optical element (DOE), a first transmission channel and a second out-coupling DOE, and wherein the second waveguide includes a second in-coupling DOE, a second transmission channel and a second out-coupling DOE; wherein a portion of the light representing the image propagates through the first in-coupling DOE, the first transmission channel and the first out-coupling DOE of the first waveguide, the portion of the light further exits from the second waveguide after propagating through the second out-coupling DOE and without propagating through the second in-coupling DOE and the second transmission channel of the second waveguide before reaching the optical receptor of the user; and wherein the portion of the light is diffracted by the first out-coupling DOE of the first waveguide into a concentrated diffraction order, and the first out-coupling DOE of the first waveguide has a diffraction grating period such that light of all diffraction orders other than the concentrated diffraction order are suppressed.

12. The near-eye display device of any of examples 1 through 11, further including: a second planar waveguide stacked together with the first waveguide; wherein the first and second waveguides include diffraction optical elements (DOEs) that have diffraction grating periods such that any diffraction orders higher than positive or negative one are suppressed.

13. The near-eye display device of example 12, further including: a third planar waveguide stacked together with the first and the second waveguides; wherein the first, second and third waveguides include diffraction optical elements (DOEs) that have diffraction grating periods such that any diffraction orders higher than positive or negative one are suppressed.

14. An apparatus including: means for generating an image, in a near eye display device, the image to be conveyed to an optical receptor of a user of the near-eye display device; means for in-coupling light representing the image at a waveguide stack including a plurality of planar waveguides; diffracting, by diffraction optical elements (DOEs) of the waveguides, the light representing the image to light beams of a plurality of diffraction orders including a concentrated diffraction order; and out-coupling the light beam of the concentrated diffraction order at a direction that the light beam of the concentrated diffraction order reaches the optical receptor of the user.

15. The apparatus of example 14, further including: means for suppressing at least some of light beams of the diffraction orders other than concentrated diffraction order so that do not reach the optical receptor of the user; wherein the diffraction orders other than the concentrated diffraction order cause ghost image effects if those diffraction orders reach the optical receptor of the user.

16. The apparatus of example 14 or 15, wherein the means for diffracting includes: means for releasing a portion of the light representing the image from an in-coupling DOE of a first waveguide of the waveguide stack, without having the portion of the light propagating through the out-coupling DOE of the first waveguide; means for diffracting, by the in-coupling DOE of the first waveguide, the portion of the light to a concentrated diffraction order; means for suppressing, by the in-coupling DOE of the first waveguide, diffraction orders other than the concentrated diffraction order; and means for guiding the portion of the light of the concentrated diffraction order through an in-coupling DOE and an out-coupling DOE of a second waveguide of the waveguide stack and toward the optical receptor of the user.

17. The apparatus of any of examples 14 through 16, wherein the means for diffracting includes: means for guiding the light representing the image through an in-coupling DOE and an out-coupling DOE of a first waveguide of the waveguide stack; means for diffracting, by the out-coupling DOE of the first waveguide, the light to a concentrated diffraction order; means for suppressing, by the out-coupling DOE of the first waveguide, diffraction orders other than the concentrated diffraction order; means for guiding a portion of the light through an out-coupler of a second waveguide of the waveguide stack without having the portion of the light propagating through the in-coupler of the second waveguide; and means for suppressing, by the out-coupler DOE of the last waveguide, diffraction orders other than the concentrated diffraction order such that the optical receptor receives no light representing a ghost image caused by the diffraction orders other than the concentrated diffraction order.

18. The apparatus of any of examples 14 through 17, further including: means for In-coupling external light from an external light source into the waveguide stack at the input surface of the waveguide stack; and means for separating, by a diffraction optical element (DOE) of the waveguide stack, the external light into a plurality of light beams with different colors and a particular concentrated diffraction order; wherein the DOE has a grating period such that at least some of the light beams from the external light source with the different colors and the particular concentrated diffraction order do not reach the optical receptor of the user.

19. A near-eye display apparatus including: means for in-coupling light representing the image to be conveyed to an optical receptor of a user of the near-eye display device; means for diffracting the light into light beams of a plurality of diffraction orders including a concentrated diffraction order; and means for out-coupling the light beam of the concentrated diffraction order at an output angle so that the light beam of the concentrated diffraction order reaches the optical receptor of the user, and suppressing some of the light beams of diffraction orders other than the concentrated diffraction order so that those light beams do not reach the optical receptor of the user or cause ghost image effects.

20. The near-eye display apparatus of example 19, further including: means for separating external light from an external light source into a plurality of light beams with different colors and a particular concentrated diffraction order; wherein the DOE has a grating period such that at least some of the light beams from the external light source with the different colors and the particular concentrated diffraction order do not reach the optical receptor of the user; wherein some of the light beams from the external light source with the different colors and the particular concentrated diffraction order cause a rainbow effect if reaching the optical receptor of the user.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A near-eye display device comprising:
an imager to generate an image based on light from a light source; and
a first planar waveguide to input light representing the image from the imager at an in-coupler region of the first waveguide and to output the light representing the image from an out-coupler region of the first waveguide toward an optical receptor of a user, the first waveguide being mounted in the near-eye display device in a tilted manner so that the in-coupler region is closer than the out-coupler region to a receptor plane of the optical receptor of the user, the receptor plane of the optical receptor of the user being perpendicular to a head-pointing vector of the user and passing through a surface of the optical receptor of the user.

2. The near-eye display device of claim 1, further comprising:
a transparent waveguide carrier upon which the first waveguide is mounted.

3. The near-eye display device of claim 1, further comprising:
an additional second planar waveguide to input light representing a second image at an additional in-coupler region of the second waveguide and to output the light representing the second image toward a second optical receptor of the user from an additional out-coupler region of the additional waveguide, the additional waveguide being mounted in the near-eye display device in a tilted manner so that the additional in-coupler region is closer than the additional out-coupler region to the receptor plane.

4. The near-eye display device of claim 1, wherein the first waveguide includes a diffraction optical element (DOE) separating external light from an external light source into a plurality of light beams of different colors, the DOE has a grating period such that when the near-eye display device is worn by the user, some of the light beams of the different colors from the external light source do not reach the optical receptor of the user.

5. The near-eye display device of claim 1, wherein the first waveguide includes a diffraction optical element (DOE) for separating external light from an external light source into a plurality of light beams with different colors and different diffraction orders, the DOE has a groove profile for concentrating light energy in a particular diffraction order, the DOE has a grating period such that the light beam of the particular diffraction order and of the different colors do not reach the optical receptor of the user.

6. The near-eye display device of claim 5, wherein the particular diffraction order is of −1 order that is a diffraction order next to the zero order, a light beam of the zero order does not change direction relative to the external light.

7. The near-eye display device of claim 1, further comprising:
a second planar waveguide stacked together with the first waveguide such that an output surface of the first waveguide faces toward an input surface of the second waveguide, the first and second waveguides being stacked in the same tilted manner so that in-coupler regions of the first and second waveguides are closer than out-coupler regions of the first and second waveguides to the receptor plane of the optical receptor.

8. The near-eye display device of claim 7, wherein each of the waveguides includes at least one diffraction optical element (DOE), the DOEs of the waveguides have diffraction groove profiles for concentrating light energy output by each of the waveguides in a particular diffraction order.

9. The near-eye display device of claim 7, wherein each of the waveguides includes at least one diffraction optical element (DOE) for concentrating light energy in a particular diffraction order, the DOEs have diffraction grating periods such that diffraction orders other than the particular diffraction order are suppressed.

10. The near-eye display device of claim 7, wherein the first waveguide includes a first in-coupling diffraction optical element (DOE), a first transmission channel and a first out-coupling DOE,
and wherein the second waveguide includes a second in-coupling DOE, a second transmission channel and a second out-coupling DOE;
wherein a portion of the light representing the image exits from the first waveguide after propagating through the first in-coupling DOE and without propagating through the first transmission channel and the first out-coupling DOE of the first waveguide, the portion of the light further enters the second waveguide and propagates through the second in-coupling DOE, the second transmission channel and the second out-coupling DOE of the second waveguide before reaching the optical receptor of the user; and
wherein the portion of the light is diffracted by the first in-coupling DOE of the first waveguide into a concentrated diffraction order, and the first in-coupling DOE of the first waveguide has a diffraction grating period such that light of all diffraction orders other than the concentrated diffraction order are suppressed.

11. The near-eye display device of claim 7, wherein the first waveguide includes a first in-coupling diffraction optical element (DOE), a first transmission channel and a second out-coupling DOE,
and wherein the second waveguide includes a second in-coupling DOE, a second transmission channel and a second out-coupling DOE;
wherein a portion of the light representing the image propagates through the first in-coupling DOE, the first transmission channel and the first out-coupling DOE of the first waveguide, the portion of the light further exits from the second waveguide after propagating through the second out-coupling DOE and without propagating through the second in-coupling DOE and the second transmission channel of the second waveguide before reaching the optical receptor of the user; and
wherein the portion of the light is diffracted by the first out-coupling DOE of the first waveguide into a concentrated diffraction order, and the first out-coupling DOE of the first waveguide has a diffraction grating period such that light of all diffraction orders other than the concentrated diffraction order are suppressed.

12. The near-eye display device of claim 1, further comprising:
a second planar waveguide stacked together with the first waveguide;
wherein the first and second waveguides include diffraction optical elements (DOEs) that have diffraction grating periods such that any diffraction orders higher than positive or negative one are suppressed.

13. The near-eye display device of claim 12, further comprising:
a third planar waveguide stacked together with the first and the second waveguides;
wherein the first, second and third waveguides include diffraction optical elements (DOEs) that have diffraction grating periods such that any diffraction orders higher than positive or negative one are suppressed.

14. A method comprising:
generating an image, in a near eye display device, the image to be conveyed to an optical receptor of a user of the near-eye display device;
in-coupling light representing the image at a waveguide stack including a plurality of planar waveguides;
diffracting, by diffraction optical elements (DOEs) of the waveguides, the light representing the image to light beams of a plurality of diffraction orders including a concentrated diffraction order; and
out-coupling the light beam of the concentrated diffraction order at a direction that the light beam of the concentrated diffraction order reaches the optical receptor of the user.

15. The method of claim 14, further comprising:
suppressing at least some of light beams of the diffraction orders other than concentrated diffraction order so that do not reach the optical receptor of the user;
wherein the diffraction orders other than the concentrated diffraction order cause ghost image effects if those diffraction orders reach the optical receptor of the user.

16. The method of claim 14, wherein the step of diffracting comprises:
releasing a portion of the light representing the image from an in-coupling DOE of a first waveguide of the waveguide stack, without having the portion of the light propagating through the out-coupling DOE of the first waveguide;
diffracting, by the in-coupling DOE of the first waveguide, the portion of the light to a concentrated diffraction order;
suppressing, by the in-coupling DOE of the first waveguide, diffraction orders other than the concentrated diffraction order; and
guiding the portion of the light of the concentrated diffraction order through an in-coupling DOE and an out-coupling DOE of a second waveguide of the waveguide stack and toward the optical receptor of the user.

17. The method of claim 14, wherein the step of diffracting comprises:
guiding the light representing the image through an in-coupling DOE and an out-coupling DOE of a first waveguide of the waveguide stack;
diffracting, by the out-coupling DOE of the first waveguide, the light to a concentrated diffraction order;
suppressing, by the out-coupling DOE of the first waveguide, diffraction orders other than the concentrated diffraction order;
guiding a portion of the light through an out-coupler of a second waveguide of the waveguide stack without having the portion of the light propagating through the in-coupler of the second waveguide; and
suppressing, by the out-coupler DOE of the last waveguide, diffraction orders other than the concentrated diffraction order such that the optical receptor receives no light representing a ghost image caused by the diffraction orders other than the concentrated diffraction order.

18. The method of claim 14, further comprising:
In-coupling external light from an external light source into the waveguide stack at the input surface of the waveguide stack; and
separating, by a diffraction optical element (DOE) of the waveguide stack, the external light into a plurality of light beams with different colors and a particular concentrated diffraction order; wherein the DOE has a grating period such that at least some of the light beams from the external light source with the different colors and the particular concentrated diffraction order do not reach the optical receptor of the user.

19. A near-eye display apparatus comprising:
means for in-coupling light representing the image to be conveyed to an optical receptor of a user of the near-eye display device;
means for diffracting the light into light beams of a plurality of diffraction orders including a concentrated diffraction order; and
means for out-coupling the light beam of the concentrated diffraction order at an output angle so that the light beam of the concentrated diffraction order reaches the optical receptor of the user, and suppressing some of the light beams of diffraction orders other than the concentrated diffraction order so that those light beams do not reach the optical receptor of the user or cause ghost image effects.

20. The near-eye display apparatus of claim 19, further comprising:
means for separating external light from an external light source into a plurality of light beams with different colors and a particular concentrated diffraction order; wherein the DOE has a grating period such that at least some of the light beams from the external light source with the different colors and the particular concentrated diffraction order do not reach the optical receptor of the user;
wherein some of the light beams from the external light source with the different colors and the particular concentrated diffraction order cause a rainbow effect if reaching the optical receptor of the user.
